(19) United States
(12) Patent Application Publication
(10) Pub. No.: US 2017/0353397 A1
(43) Pub. Date: Dec. 7, 2017

(54) Offloading Execution of an Application by a Network Connected Device

(71) Applicant: Advanced Micro Devices, Inc., Sunnyvale, CA (US)

(72) Inventor: Shuai Che, Bellevue, WA (US)

(21) Appl. No.: 15/174,624

(22) Filed: Jun. 6, 2016

(51) Int. Cl. H04L 12/911; H04L 29/08

(52) U.S. Cl. CPC H04L 47/781; H04L 67/10

(57) ABSTRACT

A client device detects one or more servers to which an application can be offloaded. The client device receives information from the servers regarding their graphics processing unit (GPU) compute resources. The client device selects one of the servers to offload the application based on such factors as the GPU compute resources, other performance metrics, power, and bandwidth/latency/quality of the communication channel between the server and the client device. The client device sends host code and a GPU computation kernel in intermediate language format to the server. The server compiles the host code and GPU kernel code into suitable machine instruction set architecture code for execution on CPU(s) and GPU(s) of the server. Once the application execution is complete, the server returns the results of the execution to the client device.

### BACKGROUND

### Field of the Invention

The disclosure relates to offloading execution of an application from one device to a second device to execute the application.

### Description of the Related Art

As the number of network connected devices continues to expand quickly, e.g., with the rapid expansion of the internet-of-things (IOT), the ability to execute certain tasks on network connected devices may be limited by the processing power available on the device. For example, certain image processing tasks may require more graphic capabilities than typically available on a mobile device.

### SUMMARY OF EMBODIMENTS OF THE INVENTION

It would be desirable for a network connected client device to utilize compute resources available in a more capable server device accessible over a network connection. Accordingly, in one embodiment, a method is provided that includes a client detecting the presence of a first server on a network. The client receives a first indication of graphic processing unit (GPU) compute resources on the first server. The client offloads an application for execution from the client to the first server, the offloading including sending to the server device GPU code for the application in an intermediate language format. The client then receives an indication of a result of execution of the application by the first server.

In another embodiment, an apparatus includes a communication logic configured to communicate with one or more servers detected on a network coupled to the communication logic. Offload management logic selects one of the one or more servers to offload an application after receiving one or more indications of graphic processing unit (GPU) compute resources on respective ones of the one or more servers. The offload logic is further configured to cause a GPU computation kernel in an intermediate language format to be sent to a selected one of the one or more servers, the GPU computation kernel associated with the application.

In another embodiment, a method includes selecting at a client at least one server of one or more servers for offloading an application for execution to the one server based at least in part on the compute resources available on the one or more servers. The client sends graphics processing unit (GPU) code in an intermediate language format to the one server and sends central processing unit (CPU) host code in the intermediate language format to the one server. The one server compiles the CPU host code in the intermediate language format into a first machine instruction set architecture (ISA) format for execution on at least one CPU of the one server. The server also compiles the GPU code in the intermediate language format into a second machine instruction set architecture (ISA) format for execution on at least one GPU of the one server. The server executes the application and returns a result to the client.

### BRIEF DESCRIPTION OF THE DRAWINGS

The present invention may be better understood, and its numerous objects, features, and advantages made apparent to those skilled in the art by referencing the accompanying drawings.

FIG. 1 illustrates an example of a system that enables seamless program/data movement from a network connected client device to a network connected server device and execution of an application on the server device with results being returned to the client device

FIG. 2 illustrates a high level block diagram of a client device seeing N server devices on a network.

FIG. 3 illustrates an example flow diagram of an offloading operation associated with the system of FIG. 1.

### DETAILED DESCRIPTION

Mobile devices, desktops, and servers and a wide variety of internet-of-things (IOT) devices are connected through networks. Seamless coordination of client devices (e.g., cell phones, laptops, and embedded devices) and servers (e.g., personal and public cloud servers, or edge devices to cloud servers) allows client devices to offload applications to be more efficiently executed on servers. If the edge devices, e.g., smart routers providing an entry point into enterprise or service provider core networks, have some compute capability, the edge devices may be used to execute offloaded applications. Offloading applications allows one device to efficiently use compute resources in another device where both devices are connected via a network. Some applications are more beneficial to run locally on client devices while others are more beneficial to run on servers when client devices are not capable of performing particular tasks efficiently. With an appropriate software infrastructure, applications can be migrated or offloaded and executed in an environment having more compute resources, particularly where more GPU resources are available.

In the current computing environment, where users can communicate via many wired and wireless communication channels, users can access a variety of computing devices connected through the network. That provides an opportunity to schedule and run a particular application on the most appropriate platform. For example, a user program on a cell phone may offload a graphics rendering application to a desktop GPU nearby in an office or to a nearby game console, or offload a machine learning application to a remote cloud platform. As another example, a user may wish to perform an image search on photos that reside on a cloud server, on a cell phone, or both. Such a search may be more efficiently performed on a server device with significant GPU resources. The decision to offload an application can be based on such factors as network connectivity, bandwidth/latency requirement of the application, data locality, and compute resources of the remote server device. GPUs are a powerful compute platform for data parallel workloads. More processors are being integrated with accelerators (e.g., graphics processing units (GPUs)) providing more opportunity to offload GPU suitable tasks. Note that as used herein, a “client” is the device requesting that an application be offloaded for execution and a “server” is the device to which the application is offloaded for execution, whether the server is a cloud based server, a desktop, a game console, or even another mobile device such as a tablet, cell phone, or embedded device. If the server device is capable of executing the application (or a portion of the application) more efficiently, then offloading can make sense.

Future wireless development (e.g., 5G) will make moving programs and data a more feasible and less expensive option (moving data is also beneficial if computation presents sufficient data locality). However, a system infrastructure is needed to allow GPU programs (and/or data) to seamlessly move and execute on other devices on the network. The client and server devices may use different architectures, which requires a portable and efficient solution. Embodiments herein utilize a framework to facilitate one device offloading a compute intensive task to another device that can more efficiently perform the task.

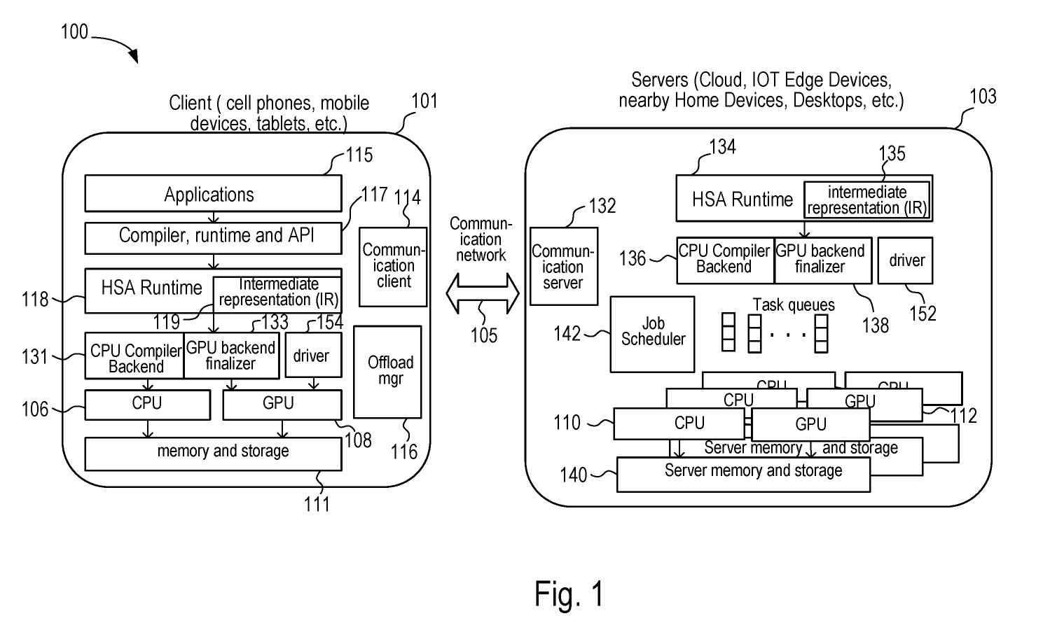

FIG. 1 illustrates an example overall system architecture 100 including the software stack to enable seamless program/data movement and execution of an application on a network connected device. The system architecture 100 includes a client node 101 and a server node 103 coupled to the client node via a communication network 105. The communication network 105 represents any or all of multiple communications networks including wired or wireless connections, such as a wireless local area network, near field communications (NFC), Long Term Evolution (LTE) cellular service, or any suitable communication channel. The actual implementation and packaging of software and hardware components can vary, but other possible instantiations of the software stack will have similar functionality and a wide variety of hardware may be used in both the client node 101 and the server 103. For example, the client 101 may be, e.g., a cell phone, a mobile device, a tablet, or any of a number of IOT devices. The client 101 may include a CPU 106, a GPU 108, and memory 111. The server 103 may include CPUs 110 and GPUs 112. While both the client and server devices may be equipped with GPUs, the server may have more powerful GPUs and a larger number than those on the client, making execution of a GPU intensive application more efficient on the server. Thus, the client may move an application to the server for execution.

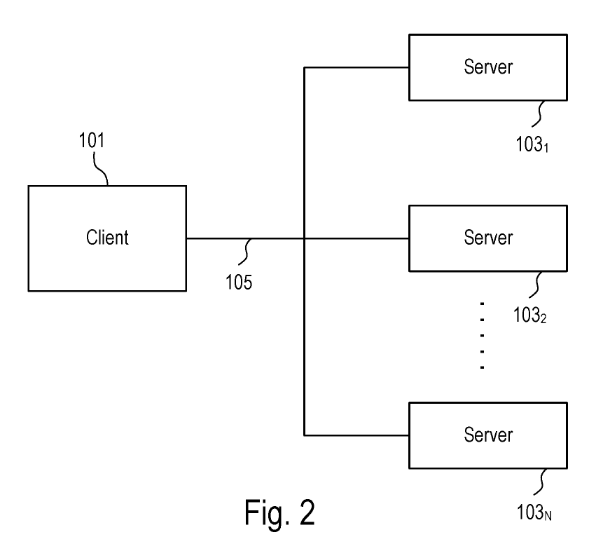

However, before the client can offload an application, the client has to be aware of servers to which an application can be offloaded. Thus, referring to FIGS. 1 and 2, the client may detect a plurality of servers 103₁, 103₂, 103_{N} available through the client communication platform 114 and communication network 105. The communication platform may exchange messages with multiple servers (e.g., with registered cloud services through a wired or wireless connection, with nearby devices through a wireless local area network, through near field communications (NFC), or through any suitable communication channel. The communication servers reply back to the client with their capabilities to support the offloading including providing information, e.g., indicating the server's GPU compute resources and runtime environment. In other embodiments, the initial message from the client may specify a runtime environment and only servers supporting that runtime environment may respond.

Embodiments herein may take advantage of heterogeneous system architecture (HSA) providing for seamless integration of CPUs and GPUs with a unified address space. In contrast to todays' cloud services, a client may also need to transfer the GPU code and CPU host code to a server (or servers) to which the client decides to offload the task. In one example, the server(s) may indicate support for the Heterogeneous System Architecture (HSA) Intermediate Language (HSAIL), which provides a virtual instruction set that can be compiled into machine instruction set architecture (ISA) code at runtime that is suitable for the particular execution unit on which the code will execute. While HSAIL is one intermediate language that may be supported, other embodiments may use other intermediate languages and the approaches described herein are general to a variety of platforms that support common intermediate languages and runtimes such as HSA.

Referring still to FIG. 1, applications 115 and compiler, runtime and application programming interface (API) 117 illustrate the layers above HSA runtime 118 and intermediate code representation 119 (e.g., HSAIL). For example, an application can be written in a high level language (e.g., OpenMP, OpenCL, or C++). The compiler, runtime, and API is for the particular language in which the application is written. The compiler compiles the high level language code to intermediate language code. The calls/functions (for task and memory management) are implemented and managed by the language runtime, and further mapped to the HSA runtime calls.

The client can evaluate the various offloading options using offload manager 116. The offload manager, which may be implemented in software, evaluates the various server options based, e.g., on the GPU compute resources available at the server, and the bandwidth/latency/quality of the communication network 105 between the server and client. The offload manager can then offload the application to the selected server(s). The client offloads an application to a remote server for purposes of performance, power, and other metrics. Thus, offloading may save power on a battery powered device thereby extending the battery life. If the offloading option is limited to one server, the evaluation of the server option is simplified to the choice as to whether the offloading is worthwhile given the compute resources available on the server, the bandwidth/latency/quality of the communication channel, power considerations, and any other considerations relevant to client device for the particular application. Other considerations may include the current utilization of the client device and/or utilization of the server device.

The client and the server may use entirely different GPU and CPU architectures. Using a runtime system supporting universal application programming interface (API) calls for job/resource management (e.g., Architected Queuing Language (AQL) in HSA), and providing instruction delivery format in an intermediate language format for GPU kernel execution, can allow offloading even with the different architectures. AQL provides a command interface for the dispatch of agent commands, e.g., for kernel execution. In an embodiment, the client and server implement the API and support the intermediate code (instruction) format. The embodiment of FIG. 1 uses HSA as an example. The runtime on the client or server (depending on whether the execution is local or remote) is responsible for setting up the environment, managing device memory buffers and scheduling tasks and computation kernels on GPUs. These tasks are achieved by making the corresponding API calls on the CPU host. The GPU compute kernels, launched by the host CPU may be stored in an intermediate format (e.g., HSAIL) on the client and delivered in the intermediate format from the client to the server.

An application, written in a high-level language, is compiled into host code with standard runtime API calls for GPU resource and task management. The application may be downloaded from a digital distribution platform, e.g., an “app” store, for mobile devices and stored on the client device or otherwise obtained by the client device. The compiled host code and GPU kernel are stored in an intermediate language format. The reason for using an intermediate language format for the host code and the GPU kernel is that client and server devices may use different GPUs as well as different CPUs. When a server executes a task offloaded from a client, the server can receive the intermediate language code and further compile the host code and the kernel code in the intermediate language to the machine ISAs format for the CPU and GPU on the server.

If the application is not offloaded by the client, the HSA environment on the client allows the host code to be compiled in the CPU compiler backend 131 from an intermediate language format into a suitable machine ISA format for the CPU 106. The GPU kernel may be compiled in the GPU backend finalizer 133 into a suitable machine ISA format for the GPU 108. On the other hand, if the application is offloaded to the server, the server communication platform 132 receives the host code and GPU kernel in the intermediate language format. The HSA runtime 134 compiles the intermediate language formatted code for the host code in CPU compiler 136 into host code suitable for execution on CPU(s) 110. In addition, the GPU backend finalizer 138 compiles the GPU kernel into a GPU machine ISA format suitable for execution on the GPU(s) 112 in the server. The host code provides control functionality for execution of the GPU kernel including such tasks as determining what region of memory 140 to use and launching the GPU kernel. The driver 152 (and 154 on the client side) in an embodiment is an HSA kernel mode driver that supports numerous HSA functions, including registration of HSA compute applications and runtimes, management of HSA resources and memory regions, creation and management of throughput compute unit (TCU) process control blocks (PCBs)(where a TCU is a generalization of a GPU), scheduling and context switching of TCUs, and graphics interoperability.

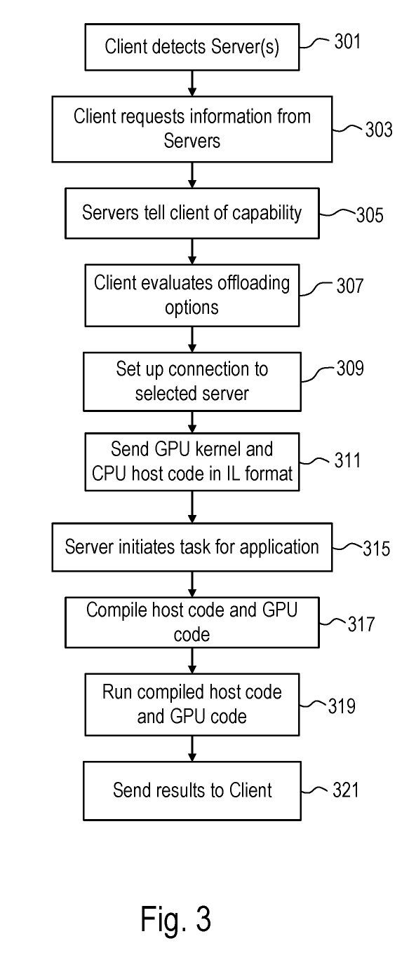

FIG. 3 illustrates a high level flow diagram of the major steps involved in offloading an application from a client to a server. In step 301, the client, which has an application that may be offloaded, detects one or more servers on the network through client communication platform 114 (FIG. 1). The communication platform may support various wired and wireless interfaces with conventional hardware and software. The client communication platform may exchange messages with multiple servers (e.g., registered cloud services, nearby devices through WiFi, or Bluetooth, LTE, or other communication channels). The client may be aware of registered cloud services based on a registry that is maintained locally to the client or remote from the client. In step 303 the client requests that the server(s) indicate their offload capability (e.g., being HSAIL compatible) along with GPU compute resources. The compute resources of a registered cloud service or an otherwise known server may become known to the client by referencing information that is local or remote to the client. In that case, the operations in step 303 and step 305 may be bypassed in part or in whole. Assuming the client requires the information about server compute resources, the server(s) reply back to the client in step 305 with their support capability including GPU compute resource information.

With the GPU information from the servers, the offload manager on the client in step 307 evaluates offloading options and decides a particular server (or servers) to offload its application and data. The evaluation includes estimating performance (or other metrics) using GPU device information from the servers, expected loading of the servers, latency/bandwidth/quality of network link to each server for data transmission. For example, one server may have superior performance but the network connection has low bandwidth while another server may have a higher bandwidth communication channel and less compute resources. Depending on the application, the offload manager picks a suitable server (or servers) for offloading the application. If the offload manager finds more than one server is suitable for the application, the offload manager may decide to offload a portion of the particular application to more than one suitable server. In other words, multiple servers may be used to complete the offloaded application. That may be particularly effective for large tasks that can run in parallel.

After client decides a specific server to offload an application, the client sets up a connection to the server in step 309. The client then sends the server in step 311 the GPU computation kernel in an intermediate language format, along with the CPU host code also in an intermediate format with embedded runtime API calls for host control. Depending on the application, the client may also send the data (e.g., files) through the network to the server, or the client can send pointers to where the files are located on the server's storage (e.g., in a cloud service). Where execution of a task is to be partitioned between servers, data may be partitioned between servers.

On the server side, after receiving code and any needed data from the client, the server initiates a task for the application in step 315. The code (both host and kernel) in the intermediate format is further compiled into the machine ISAs by the backend finalizers on the server (CPU compiler backend 136 and GPU backend finalizer 138) in step 317. The job scheduler 142 creates a process and runs the CPU host code and GPU kernel code on server CPU and GPU processors in step 319. The host API calls are mapped to specific implementations on the server. After the job is completed, the result is sent back to the client in step 321 and the communication link is closed. The result may include data or a pointer to where data is located.

Thus, as described above, a connected device can take advantage of compute resources available over a network to more efficiently execute applications on a different machine. The description of the invention set forth herein is illustrative, and is not intended to limit the scope of the invention as set forth in the following claims. For example, in some embodiments only CPU code is offloaded for execution. Other variations and modifications of the embodiments disclosed herein, may be made based on the description set forth herein, without departing from the scope of the invention as set forth in the following claims.

What is claimed is:

1. A method, comprising:
a client detecting a first server on a network;
receiving, at the client, a first indication of graphics processing unit (GPU) compute resources on the first server;
offloading an application for execution from the client to the first server, the offloading including sending GPU code for the application in an intermediate language format to the first server; and
receiving, at the client, a result of execution of the application by the first server.

2. The method as recited in claim 1, wherein the offloading of the application further comprises the client sending central processing unit (CPU) host code in an intermediate language format to the first server.

3. The method as recited in claim 2, further comprising:
after receiving the GPU code in the intermediate language format and receiving the CPU host code in the intermediate language format, the first server compiling the GPU code in the intermediate format into a first machine instruction set architecture (ISA) format and compiling the CPU host code into a second machine ISA format.

4. The method as recited in claim 1, further comprising the client sending data to the first server for use in execution of the application.

5. The method as recited in claim 1, further comprising the client sending to the first server one or more pointers to where data is located on storage accessible to the first server.

6. The method as recited in claim 1, further comprising:
offloading the application for execution to a second server; and
the first and second servers executing respective portions of a task associated with the application.

7. The method as recited in claim 1, further comprising:
prior to offloading the application to the first server, receiving, at the client, a second indication of GPU compute resources on a second server; and
selecting the first server to offload the application instead of the second server based at least in part on performance capability of the first server, the performance capability being determined, at least in part, according to the first indication of GPU compute resources on the first server as compared to the second indication of GPU compute resources on the second server.

8. The method as recited in claim 1, further comprising:
prior to offloading the application to the first server, receiving, at the client, a second indication of GPU compute resources on a second server; and
selecting the first server to offload the application instead of the second server based, at least in part, on better communications with the first server as compared to the second server,
wherein the better communications is determined according to at least one of latency and bandwidth of a first communication channel between the first server and the client as compared to latency and bandwidth of a second communication channel between the second server and the client.

9. The method as recited in claim 1, further comprising:
after receiving the GPU code in the intermediate language format from the client, the first server initiating a task to execute the application, the task including compiling the GPU code in the intermediate format into a first machine instruction set architecture (ISA) format for execution on the server.

10. The method as recited in claim 1, wherein the result received includes data.

11. An apparatus, comprising:
communication logic configured to communicate with one or more servers detected on a network coupled to the communication logic;
offload management logic configured to:
select at least one of the one or more servers to offload an application after receiving one or more indications of graphics processing unit (GPU) compute resources on respective ones of the one or more servers; and
cause a GPU computation kernel in an intermediate language format to be sent to a selected one of the one or more servers, the GPU computation kernel associated with the application.

12. The apparatus as recited in claim 11, wherein the offload management logic is further configured to send central processing unit (CPU) host code in the intermediate language format to the server, the CPU host code associated with the application.

13. The apparatus as recited in claim 12, further comprising:
the selected server, the selected server including,
a first compiler to compile the GPU computation kernel code in the intermediate format into first code having a first machine instruction set architecture (ISA) format for execution on at least one GPU of the selected server; and
a second compiler to compile the central processing unit host code in the intermediate language format into a second code having a second machine ISA format for execution on at least one CPU of the selected server.

14. The apparatus as recited in claim 11, wherein the offload management logic is further configured to send data to the selected one of the one or more servers for use in execution of the application.

15. The apparatus as recited in claim 11, wherein the offload management logic is further configured to send one or more pointers to where data is located on storage accessible to the selected one of the one or more servers.

16. The apparatus as recited in claim 11, wherein the offload management logic is further configured to select the selected one of the one or more servers based at least in part on performance capability of the selected server.

17. The apparatus as recited in claim 11,
wherein the offload management logic is further configured to select the selected one of the one or more servers based at least in part on better communications with the selected server as compared to others of the servers; and
where in the apparatus is a client and the better communications is determined according to at least one of latency and bandwidth of a first communication channel between the client and the selected server as compared to latency and bandwidth of one or more other communication channels between one or more other servers and the client.

18. The apparatus as recited in claim 11, further comprising:
the selected server, the selected server including a compiler to compile the GPU computation kernel code in the intermediate format into a first machine instruction set architecture (ISA) format for execution on at least one GPU of the selected server.

19. A method, comprising:
selecting, at a client, at least one server of one or more servers for offloading an application for execution to the one server based at least in part on the compute resources available on the one or more servers;
sending GPU code in an intermediate language format to the one server and sending central processing unit (CPU) host code in the intermediate language format to the one server;
at the one server, compiling the CPU host code in the intermediate language format into a first machine instruction set architecture (ISA) format for execution on at least one CPU of the one server;
at the one server, compiling the GPU code in the intermediate language format into a second machine ISA format for execution on at least one GPU of the one server;
executing the application on the one server; and
returning a result to the client.

20. The method as recited in claim 19, further comprising:
prior to offloading the application to the one server, receiving at the client, a second indication of GPU compute resources on a second server; and
selecting the one server to offload the application instead of the second server further based on better communications with the one server as compared to the second server,
wherein the better communications is determined according to at least one of latency and bandwidth of a first communication channel between the one server and the client as compared to latency and bandwidth of a second communication channel between the second server and the client.
